(19) United States
(12) Patent Application Publication
(10) Pub. No.: US 2023/0403974 A1
(43) Pub. Date: Dec. 21, 2023

(54) Arrangement of a mowing head, an output shaft for receiving a mowing head and a fastening device for fixing the mowing head on the output shaft, and work apparatus with such an arrangement

(71) Applicant: Andreas Stihl AG & Co. KG, Waiblingen (DE)

(72) Inventors: Timo Förg, Aspach (DE); Andreas Sorg, Schorndorf (DE)

(73) Assignee: Andreas Stihl AG & Co. KG, Waiblingen (DE)

(21) Appl. No.: 18/331,337

(22) Filed: Jun. 8, 2023

(30) Foreign Application Priority Data
Jun. 10, 2022 (EP) 22 178 487.9

(51) Int. Cl. A01D 34/416

(52) U.S. Cl. CPC A01D 34/4165

(57) ABSTRACT

An assembly includes a mowing head (3), an output shaft (8), and a fastening device (10). The output shaft (8) is drivable in rotation about an axis of rotation (9). The assembly (2) has an anti-rotation lock (11) and an axial lock (16). The mowing head (3) is held corotatingly on the output shaft (8) by the anti-rotation lock (11). The axial lock (16) locks the mowing head (3) in a blocking position (30) of the output shaft (8) against a relative movement in the direction of the axis of rotation (9) of the output shaft (8) and in an inoperative position (31) releases the mowing head (3) for detachment from the output shaft (8). The fastening device (10) includes an actuating element (24) accessible to the operator. The axial lock (16) is switchable into the blocking position (30) and into the inoperative position (31) by the actuating element (24).

### CROSS-REFERENCE TO RELATED APPLICATION

This application claims the benefit of European Patent Application No. 22178487.9, filed 10 Jun. 2022, the contents of which are incorporated by reference in their entireties.

### TECHNICAL FIELD

The disclosure relates to an assembly of a mowing head, an output shaft for receiving a mowing head and a fastening device for fixing the mowing head to the output shaft, and to a work apparatus with such an assembly.

### BACKGROUND

Brush cutters are used for mowing grass, undergrowth, or the like. For this purpose, a mowing head with a tool is driven to rotate about an axis of rotation of the mowing head, as a result of which the grass or undergrowth is cut off when it comes into contact with the tool. Cutting knives, cutting line or the like can be provided as the tool. Within the context of the present disclosure, the term “brush cutter” should be understood to include string trimmers.

Brush cutters having a mowing head that is detachably held on an output shaft are generally known. For this purpose, the mowing head is usually attached to the output shaft of the brush cutter via a screw connection. A disadvantage of such assemblies is that the output shaft has to be fixed in order to screw the mowing head on and off. For this purpose, stops, such as locking pins, for example, are provided which block rotation of the gearing or the output shaft. The gearing or the output shaft is usually fixed with tools that the operator then has to always carry with them when operating the brush cutter. Alternatively, suitable tools are mounted on the brush cutter. The detachment and attachment of the mowing head to the output shaft is therefore complex and time-consuming.

### SUMMARY

The disclosure is based on the object of specifying an assembly of a mowing head, an output shaft for receiving a mowing head and a fastening device for fixing the mowing head on the output shaft, which allows a simple and quick attachment/detachment of the mowing head to/from the output shaft.

This object is achieved by an assembly of a mowing head, an output shaft for receiving the mowing head, and a fastening device for fixing the mowing head on the output shaft as disclosed and claimed.

The assembly comprises a mowing head, an output shaft, and a fastening device. The output shaft can be driven in rotation about an axis of rotation. The assembly has an anti-rotation lock and an axial lock. The mowing head is held on the output shaft by the anti-rotation lock so as to corotate therewith. In a blocking position, the axial lock secures the mowing head on the output shaft positively against relative movement in the direction of the axis of rotation of the output shaft and, in an inoperative position, releases the mowing head for detachment from the output shaft. The fastening device comprises an actuating element that is accessible to the operator, with the axial lock being able to be switched into the blocking position and into the inoperative position by the actuating element.

To release the mowing head from the output shaft, the operator switches the axial lock to the inoperative position using the actuating element and then removes the mowing head from the output shaft. This allows the mowing head to be detached from the output shaft quickly and easily. For example, the operator can change and/or refill the cutting means of the mowing head or even replace the entire mowing head.

Furthermore, it is advantageous that the axial lock secures the mowing head on the output shaft in a form-fitting manner against relative movement in the direction of the axis of rotation of the output shaft. The mowing head is thus secured in the axial direction, that is to say in the direction of the axis of rotation of the mowing head, on the output shaft independent of rotation.

The anti-rotation lock is particularly preferably designed as a form-fitting connection. By designing the anti-rotation lock as a form-fitting connection, the mowing head is arranged on the output shaft so as to rotate therewith both in a first direction of rotation about the axis of rotation and in a second direction of rotation opposite to the first direction of rotation. That is, the mowing head can be driven to rotate both clockwise and counterclockwise.

The fastening device is preferably designed in such a way that the mowing head can be fastened on and detached from the output shaft without tools. This enables the operator to change the mowing head quickly and easily at the brush cutter's site of operation. It is not necessary to carry tools or the like for detaching and/or fastening the mowing head from/on the output shaft.

It is advantageously provided that the axial lock comprises a holding contour and a locking contour, with the holding contour engaging in the locking contour in the blocking position of the axial lock. The mowing head is secured axially on the output shaft by the interlocking of the holding contour and the locking contour. If the operative connection between the holding contour and the locking contour is removed, the axial lock is in its inoperative position.

Particularly advantageously, the holding contour is designed to be radially displaceable by the actuating element in particular with respect to the axis of rotation of the output shaft. The holding contour is advantageously part of the fastening device, and the locking contour is preferably formed on the mowing head. In an alternative embodiment of the assembly, it can also be provided that the holding contour is part of the mowing head, and the locking contour is formed on the output shaft.

The holding contour is particularly preferably formed on a slide frame. The slide frame advantageously includes an opening, with the locking contour preferably being arranged in the opening of the slide frame. If the axial lock is in its blocking position, the slide frame rests with its holding contour on the locking contour of the mowing head, as a result of which the mowing head is secured axially on the slide frame. If the axial lock is in its inoperative position, the locking contour of the mowing head is exposed in the opening of the slide frame of the fastening device, so that the locking contour of the mowing head can be pulled out of the opening of the slide frame.

In an alternative embodiment of the assembly, it can also preferably be provided that the holding contour is formed by at least one blocking body, in particular a ball, engaging in the locking contour.

It is advantageously provided that the fastening device comprises a base body formed in one piece, with a fan wheel being formed on the base body of the fastening device. The base body preferably has a receiving pocket, with the actuating element of the fastening device being held in the receiving pocket. The fastening device particularly preferably comprises only a single actuating element. Thus, the operator only has to actuate this actuating element in order to release the mowing head.

It is preferably provided that the assembly comprises a spring element, the spring element being operatively connected to the holding contour in such a way that the holding contour is tensioned in the locking contour. As a result, the holding contour is prestressed into the locking contour via the spring element. In order to release the mowing head from the output shaft, the actuating element must be pressed in against the spring force of the spring element until the holding contour releases the locking contour of the output shaft again and the axial lock is in the inoperative position. The mowing head can then be removed from the output shaft. It can advantageously also be provided that the actuating element engages in an open position. The operator can easily remove the mowing head from the output shaft without having to constantly press the actuating element. In an alternative embodiment, it can also be provided that no spring element is provided. The holding contour and the locking contour are arranged relative to one another in such a way that during operation of the assembly the holding contour is pressed into the locking contour by centrifugal force acting on the holding contour. As a result, a secure operative connection between the holding contour and the locking contour is ensured even without a spring element.

It is advantageously provided that the assembly comprises a latching unit, the latching unit comprising the actuating element, the holding contour, and all components via which the holding contour and the actuating element are operatively connected to one another. The center of mass of the latching unit lies outside the axis of rotation in such a way that during operation of the assembly the centrifugal forces acting on the latching unit reinforce the clamping of the holding contour against the locking contour in the blocking position. This reinforces the axial lock of the mowing head on the output shaft.

The disclosure is based on the further object of developing a handheld work apparatus in such a way that a mowing head can be easily attached on and detached from the output shaft. This object is achieved by a handheld work apparatus as disclosed and claimed.

Further features of the invention result from the description and the drawing, in which exemplary embodiments described in detail below are reproduced.

### BRIEF DESCRIPTION OF THE DRAWINGS

FIG. 1 shows a perspective view of a brush cutter.

FIG. 2 shows a perspective view of a front housing and a mowing head attached to the front housing.

FIG. 3 shows the assembly of the front housing and the mowing head according to FIG. 2 in a perspective view from above.

FIGS. 4 and 5 show a perspective view of the mowing head and the front housing in a disassembled state.

FIG. 6 shows the mowing head and the fastening device mounted on the output shaft in a lateral sectional view.

FIG. 7 shows the fastening device with mounted mowing head in a sectional view along the arrows VII according to FIG. 6.

FIG. 8 shows a lateral sectional view of the mowing head in the unlocked state on the fastening device.

FIG. 9 shows the fastening device with unlocked mowing head in a sectional view along the arrows IX according to FIG. 9.

FIG. 10 shows the fastening device and the output shaft in a perspective exploded view.

FIG. 11 shows the fastening device with locked latching unit in a partial sectional view.

FIGS. 12 to 15 show the latching unit in different perspectives.

FIG. 16 shows an alternative assembly with an axial lock between the mowing head and the fastening device in the blocking position.

FIG. 17 shows the assembly according to FIG. 16 in the inoperative position.

FIG. 18 shows the assembly according to FIG. 16 in a partial exploded view.

FIG. 19 shows a further alternative assembly with balls for axial securing in the blocking position.

FIG. 20 shows the assembly according to FIG. 19 in the inoperative position.

FIG. 21 shows a perspective exploded view of a further, alternative assembly of a mowing head (only partially shown) and an output shaft.

FIG. 22 shows a sectional view of the assembly according to FIG. 21 in the blocking position of the mowing head.

FIG. 23 shows a sectional view of the mowing head according to FIG. 21 in the inoperative position.

FIG. 24 shows a perspective view of the blocking elements of the mowing head in the inoperative position.

FIG. 25 shows a schematic sectional representation of an alternative embodiment of the mowing head with a rotatable, axial lock in the blocking position.

FIG. 26 shows a schematic sectional illustration of the mowing head according to FIG. 25 in the inoperative position.

### DETAILED DESCRIPTION

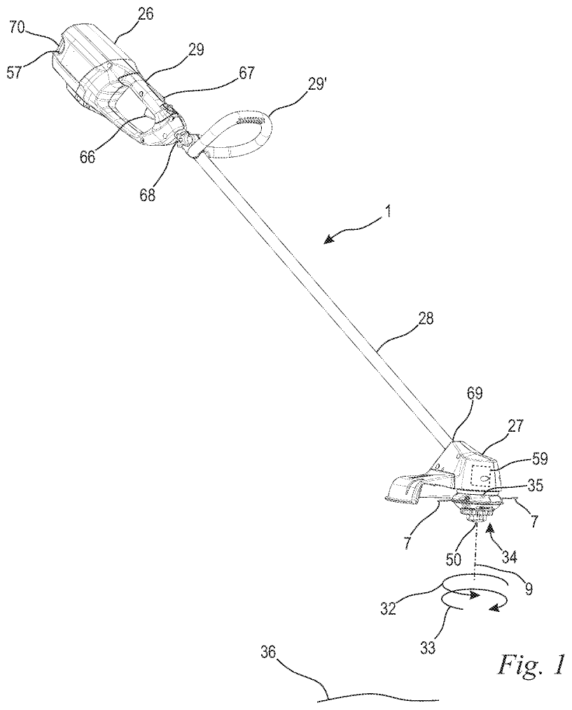

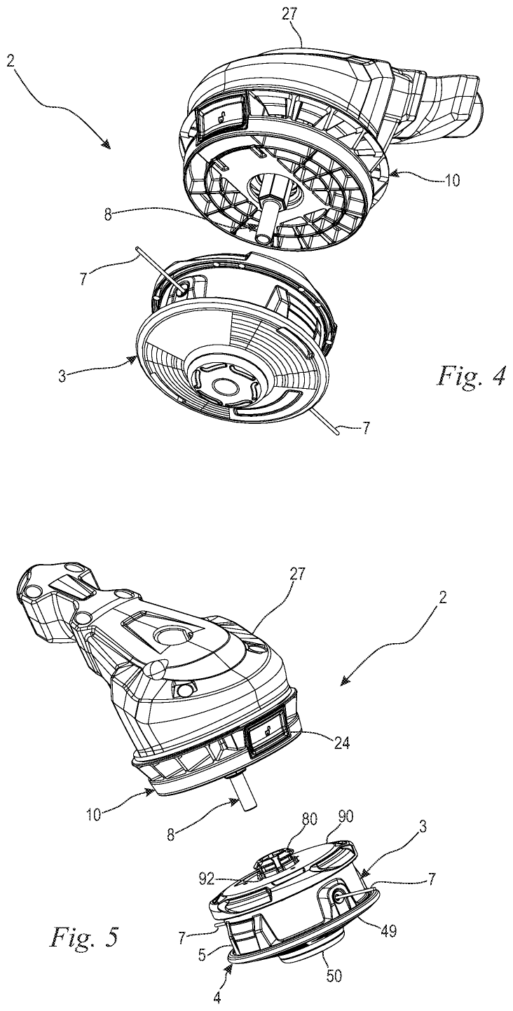

FIG. 1 shows a brush cutter as an exemplary embodiment of a handheld work apparatus 1. The work apparatus 1 comprises a rear housing 26 in which a battery 70 is arranged in the exemplary embodiment. The battery is held in the rear housing 26 by a battery latch 57. A handle 29 is advantageously formed on the rear housing 26, on which a throttle trigger 66 and a throttle trigger lock 67 for operating the work apparatus 1 are arranged. The rear housing 26 is connected to a front housing 27 via a hollow guide tube 28. The rear housing 26 is arranged at a first end 68 of the guide tube 28 and the front housing 27 at a second end 69 of the guide tube 28. In the exemplary embodiment, a drive motor 59, shown only schematically, is arranged in the front housing 27 and is designed as an electric motor in the exemplary embodiment. An output shaft 8 driven by the drive motor 59 protrudes from the front housing 27 (FIG. 4). The output shaft 8 drives a mowing head 3 held on the output shaft 8 in rotation. The mowing head 3 is driven about an axis of rotation 9 in a first direction of rotation 32, and in also in a second direction of rotation 33 opposite to the first direction of rotation 32. The mowing head 3 has at least one cutting tool 7, which is designed in the present embodiment in the form of two trimmer lines. The cutting tool 7 can also be in the form of cutting blades that are attached to the mowing head 3. The cutting tool 7 is used for cutting foliage such as grass, undergrowth, or the like. On the mowing head 3 there is a bottom side 34 which faces the ground 36 during operation and which is arranged on the side of the mowing head 3 facing away from the guide tube 28. The top side 35 of the mowing head 3 is formed on the side of the mowing head 3 facing the tube 28. An actuating element 50 is advantageously arranged on a bottom side 34 of the mowing head 3 for readjusting the trimmer lines. Adjacent to the rear housing 26, a further handle 29′ is provided on the guide tube 28, which is designed as a handlebar in the exemplary embodiment.

In an alternative embodiment of the work apparatus 1 that is not shown in detail, the drive motor 59 can also be designed as an internal combustion engine. The drive motor 59 is then preferably arranged in the rear housing 26, with a drive shaft running in the tube 28. Provision can be made for the drive shaft in the tube to be connected directly to the output shaft 8 for the mowing head 3 and/or to form the output shaft 8, so that no gearing is interposed. Alternatively, a gearing is provided in the front housing 27. In the case of a drive motor 59 designed as an electric motor, it can also be advantageous to arrange the drive motor 59 in the rear housing 26.

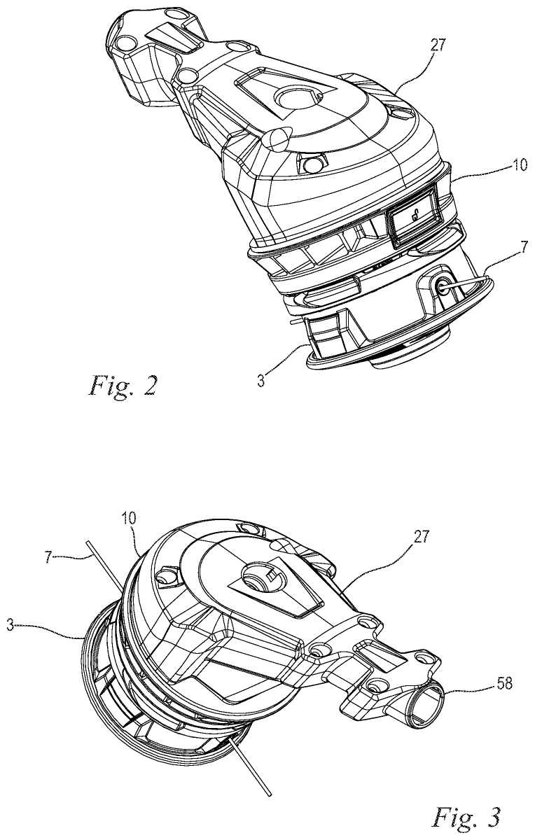

In FIGS. 2 and 3, an assembly of the front housing 27, a fastening device 10, and the mowing head 3 are shown. The front housing 27 includes a receptacle 58 for attachment to the second end 69 of the guide tube 28.

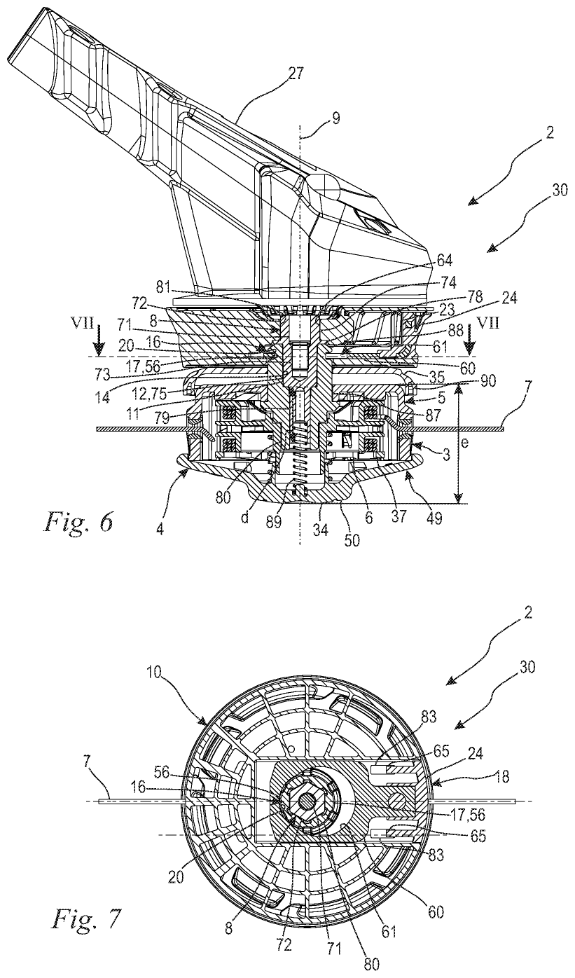

In FIGS. 4 and 5, the assembly 2 of the fastening device 10, the mowing head 3, and the output shaft 8 is shown. The mowing head 3 is detached from the output shaft 8. The output shaft 8 protrudes from the front housing 27. The output shaft 8 extends through the fastening device 10. As shown in FIG. 6, the output shaft 8 comprises a shaft 71 driven by the drive motor 59 and an intermediate shaft 72. In the exemplary embodiment, the intermediate shaft 72 is attached to the shaft 71 via a screw connection 73. In an alternative embodiment, other types of attachments may also be used. In an alternative embodiment, the output shaft 8, consisting of the shaft 71 and the intermediate shaft 72, may be designed in one piece. It can be advantageous that the driven shaft 71 forms the rotor shaft of the electric motor.

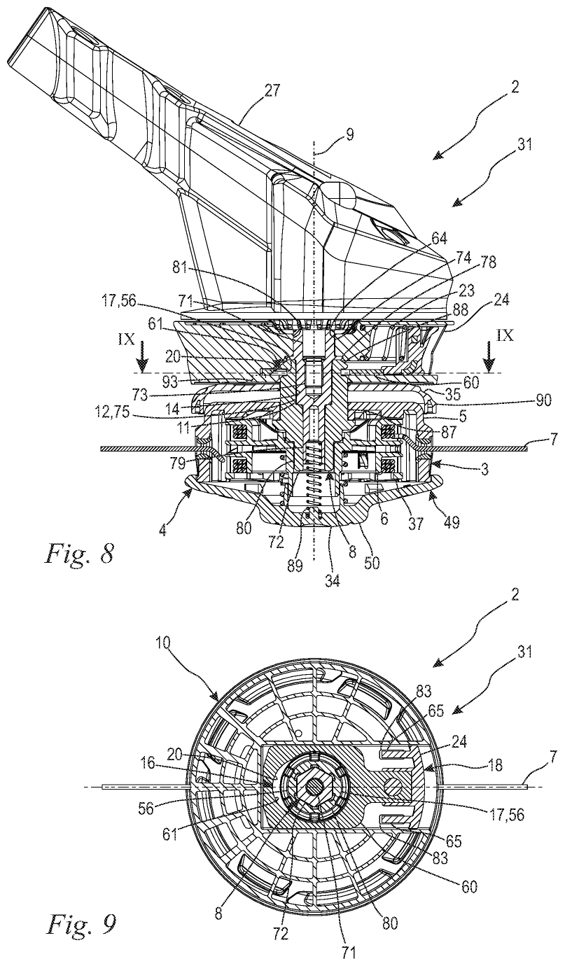

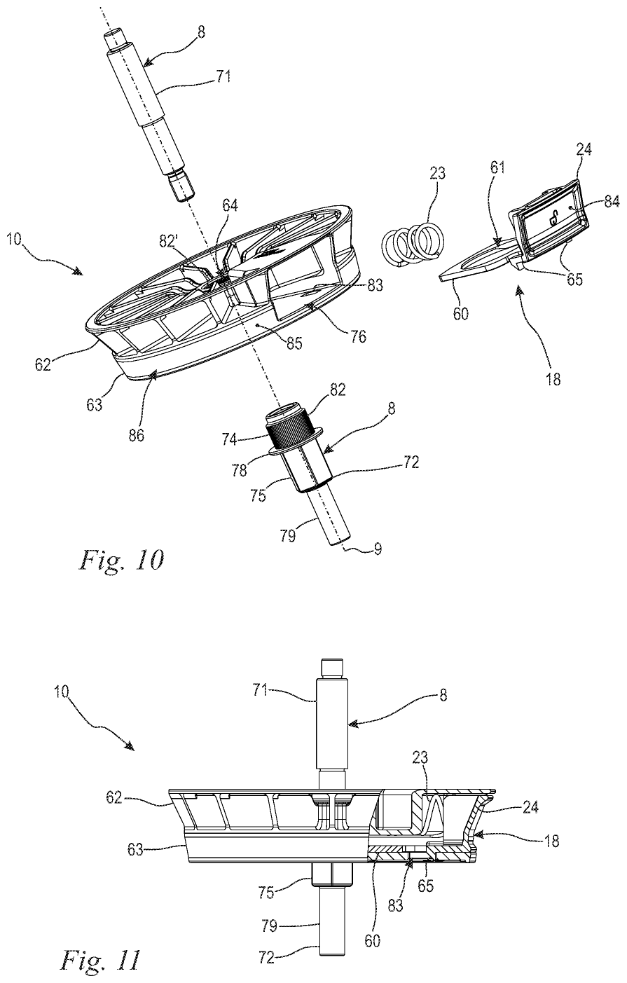

As shown in FIGS. 6 and 8, the intermediate shaft 72 has a first holding section 74 on its circumference. The fastening device 10 is held on the first holding section 74 in a rotationally fixed manner in relation to the directions of rotation 32, 33. In the preferred embodiment, the fastening device 10 is held on the output shaft 8, in particular on the first holding section 74 of the intermediate shaft 72, via a press connection 81. The fastening device 10 includes a hub 64. The hub 64 of the fastening device 10 sits on the first holding section 74. As shown in FIG. 10, the first holding section 74 is provided with a knurl 82. The hub 64 is also provided with a knurl 82′ on its surface which contacts the first holding section 74. The mutually interlocking knurls 82, 82′ between the hub 64 of the fastening device 10 and the first holding section 74 of the intermediate shaft 72 in connection with the press connection 81 increase the maximum torque that can be transmitted between the output shaft 8 and the fastening device 10. The intermediate shaft 72 includes a shaft shoulder 78. The shaft shoulder 78 is preferably directly adjacent to the first holding section 74 of the intermediate shaft 72. The shaft shoulder serves to axially secure the fastening device 10 on the intermediate shaft 72, in particular as an axial stop when the fastening device 10 is pressed onto the output shaft 8. In an alternative embodiment, it can also be expedient to provide only a press connection or another connection, by means of which the fastening device 10 is held on the output shaft 8 in a rotationally fixed manner.

As shown in FIGS. 6 and 8, the mowing head 3 is held on the output shaft 8. The mowing head 3 is held corotatingly on the output shaft 8 by means of an anti-rotation lock 11. The anti-rotation lock 11 prevents relative rotation between the mowing head 3 and the output shaft 8. In the preferred exemplary embodiment, the anti-rotation lock 11 is formed by a form-fitting connection. It may also be useful to provide an alternative corotating connection. The anti-rotation lock 11 is formed from a first part 12 and a second part 14. In the preferred exemplary embodiment, the first part 12 of the anti-rotation lock is formed by a second holding section 75 of the intermediate shaft 72. As shown in particular in FIG. 10, the second holding section 75 is designed as a hexagon. The mowing head 3 can be positively held in the direction of rotation 32, 33 on the output shaft 8 via the hexagon.

In an alternative embodiment, the shaft 71 of the output shaft 8 can be designed as a through shaft. In such an embodiment, an intermediate shaft 72 is not necessary. The first holding section 74, the shaft shoulder 78 and/or the second holding section 75 are preferably formed on the shaft 71. In a further embodiment, provision can be made for the first holding section 74, the shaft shoulder 78 and/or the second holding section 75 to be formed by one or more sleeves which are attached to the shaft 71.

As shown in FIGS. 6 and 8, the mowing head 3 includes a receiving unit 80. The mowing head 3 is held on the output shaft 8 via the receiving unit 80. The receiving unit 80 abuts the hexagon of the intermediate shaft 72 with a counter-contour. The counter-contour of the receiving unit 80 thus forms the second part 14 of the anti-rotation lock 11. When the mowing head 3 is attached on the output shaft 8, the first part 12 of the anti-rotation lock 11, in particular the hexagon of the second holding section 75 of the intermediate shaft 72, is non-rotatably connected, in particular positively connected, with the second part 14 of the anti-rotation lock 11, in particular the counter-contour of the receiving unit 80 of the mowing head 3.

As shown in particular in FIGS. 6, 8 and 10, the output shaft 8, in particular the intermediate shaft 72, comprises a guide section 79. The guide section 79 connects to the second holding section 75 of the intermediate shaft 72. The guide section 79 serves to place the mowing head 3 thereon, as a result of which it is supported radially with respect to the axis of rotation 9 of the output shaft 8. This stabilization of the mowing head 3 radially to the axis of rotation 9 is advantageous in particular against high speeds or other loads that act on the mowing head 3. Furthermore, the guide section 79 extends in the direction of the axis of rotation 9 over an immersion depth d. The immersion depth d corresponds to at least 30%, preferably at least 50%, of the total height e of the mowing head 3 measured in the direction of the axis of rotation 9 when mounted on the output shaft 8.

The intermediate shaft 72 consequently comprises a first holding section 74, a shaft shoulder 78 adjoining the first holding section 74, a second holding section 75 adjoining the shaft shoulder 78, and a guide section 79 adjoining the second holding section 75. The first holding section 74 of the intermediate shaft 72 and the second holding section 75 of the intermediate shaft 72 are separated by the shaft shoulder 78. The assembly of the sections corresponds to the sequence mentioned running in the direction from the front housing 27 to the mowing head 3.

As shown in particular in FIGS. 10 and 11, the fastening device 10 comprises a base body 63 and a latching unit 18. The base body 63 advantageously has a fan wheel 62. When the fastening device 10 is in the installed state, the fan wheel 62 is arranged facing the front housing 27. When the work apparatus 1 is in operation, the fastening device 10 and thus also the fan wheel 62 are driven in rotation by the output shaft 8. The fan wheel 62 thus generates a flow of cooling air to cool the drive motor 59. The fastening device 10 comprises a receiving pocket 76 The latching unit 18 is held in the receiving pocket 76. The receiving pocket 76 is formed on the base body 63. The hub 64 of the fastening device 10 is also formed on the base body 63. The base body 63 of the fastening device 10 is preferably designed in one piece. The base body 63 is preferably made of plastic. In the preferred embodiment, only a single latching unit 18 is provided. In an alternative embodiment, it can also be expedient to provide several latching units 18, in particular two latching units 18.

As shown in particular in FIGS. 6 and 8, the assembly 2 of the mowing head 3, the output shaft 8 and the fastening device 10 comprises an axial lock 16. The axial lock 16 can be switched into a blocking position 30 (FIGS. 6 and 7) and into an inoperative position 31 (FIGS. 8 and 9). In the blocking position 30 of the axial lock 16, the mowing head 3 is positively secured on the output shaft 8 against relative movement in the direction of the axis of rotation 9 of the output shaft 8. In the inoperative position 31 of the axial lock 16, the mowing head 3 is released for detachment from the output shaft 8. The axial lock 16 is actuated via an actuating element 24. The actuating element 24 is part of the fastening device 10. The actuating element 24 is arranged on the base body 63 of the fastening device 10 in such a way that it is accessible to the operator. To actuate the actuating element 24, the operator must press in the actuating element 24.

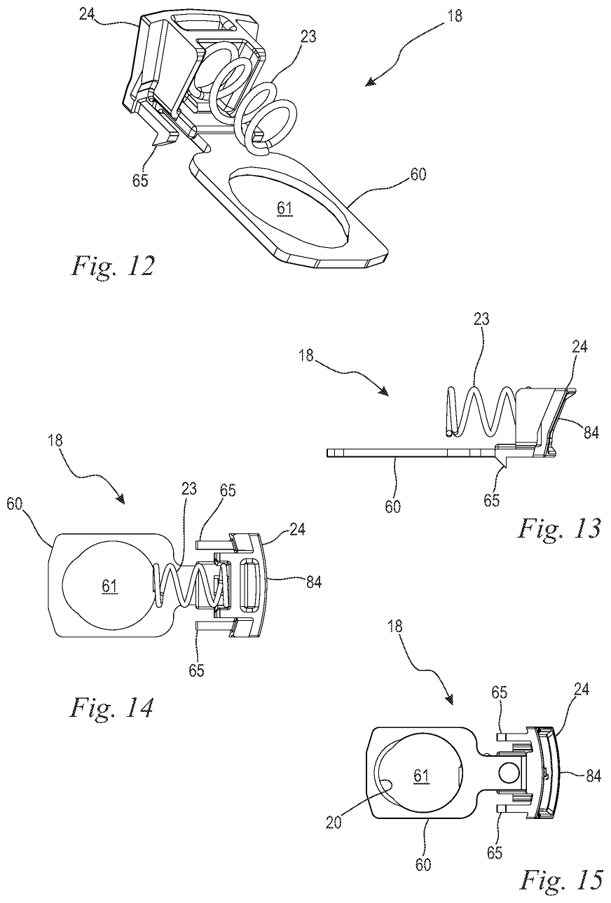

As shown in particular in FIGS. 6 and 8, the axial lock 16 is formed from the latching unit 18 and a locking contour 56. The latching unit 18 is shown in FIGS. 12-15. In the preferred exemplary embodiment, the latching unit 18 comprises the actuating element 24, a slide frame 60 that is operatively connected to the actuating element 24, and a spring element 23. The actuating element 24 is preferably made of plastic. The slide frame 60 is, in particular, designed to be flat. The slide frame 60 is advantageously formed from a metal material. In the exemplary embodiment, the actuating element 24 is formed in one piece with the slide frame 60. The slide frame 60 is partially overmolded with the actuating element 24. A holding contour 20 is provided on the slide frame 60. The slide frame 60 preferably includes an opening 61. The holding contour 20 is particularly preferably formed on the opening 61 of the slide frame 60.

As shown in particular in FIGS. 6 and 8, the latching unit 18 is arranged in the receiving pocket 76 of the fastening device 10. The spring element 23 acts with a force on the latching unit 18 in such a way that the latching unit 18 is pretensioned radially outwardly relative to the axis of rotation 9. The latching unit 18 is secured in the receiving pocket 76 of the fastening device via a snap connection. The spring element 23 is preferably designed as a helical spring. On the other hand, it can also be expedient to provide a different spring shape. One end of the spring element 23 of the latching unit 18 is supported on the base body 63 of the fastening device 10. With the other end of the spring element 23, the spring element 23 acts on the latching unit 18 and presses it radially away from the axis of rotation 9. In the exemplary embodiment, the other end of the spring element 23 is in direct contact with the actuating element 24 of the latching unit 18.

As shown in FIGS. 10 and 11, the snap connection is formed from at least one snap hook 65 of the latching unit 18 and from at least one hook opening 83 in the base body 63 of the fastening device 10. In the preferred embodiment, the latching unit 18 comprises two snap hooks 65. The snap hooks 65 are formed on the actuating element 24. It is also possible to provide the snap hooks 65 on the slide frame 60. When the fastening device 10 is in the assembled state, the snap hooks 65 engage in hook openings 83 and form the snap connection. The hook openings 83 are provided in the receiving pocket 76 of the base body 63 of the fastening device 10. The snap connection forms a radial outer stop in the base body 63 for the latching unit 18 in relation to the axis of rotation 9. Accordingly, it is possible for the operator to press the actuating element 24 against the spring force of the spring element 23 towards the axis of rotation 9. If the operator lets go of the actuating element 24, the actuating element 24 is pushed radially away from the axis of rotation 9 by the spring element 23 until the snap hooks 65 come to rest in the hook opening 83 and fix the latching unit 18 in the base body 63. In the non-actuated state of the actuating element 24, an outer side 84 of the actuating element 24 facing away from the axis of rotation 9 and an outer side 85 of the base body 63 facing away from the axis of rotation 9 are aligned flush with one another. Thereby, the operator can easily see and/or feel that the latching unit 18 is in the blocking position 30. The outer side 84 of the actuating element 24 and the outer side 85 of the base body 63 form the peripheral side 86 of the fastening device 10. The latching unit 18 is detachably attached to the base body 63 via the snap connection. If the operator wants to clean the latching unit 18, they can disassemble the latching unit 18 in a simple manner. To release the latching unit 18, the snap hooks 65 must be pressed out of the hook openings 83 in the base body 63. This causes the axial stop of the spring hooks to be removed, as a result of which the latching unit 18 is pressed out of the receiving pocket 76 of the base body 63 by the spring element 23.

As shown in FIGS. 6 and 7, the mowing head 3 is held on the output shaft 8 in the axial direction, i.e., in the direction of the axis of rotation 9, by the fastening device 10. The mowing head 3 is axially fixed on the output shaft 8 by the axial lock 16. The axial lock 16 is formed from the holding contour 20 of the latching unit 18 and from the locking contour 56. The locking contour 56 is formed on the receiving unit 80 of the mowing head 3. In the blocking position 30 of the axial lock 16, the holding contour 20 is connected to the locking contour 56 in such a way that a relative movement of the mowing head 3 in the direction of the axis of rotation 9 is prevented. The holding contour 20 forms an axial stop for the locking contour 56. The holding contour 20 and the locking contour 56 are preferably designed in such a way that an axial relative movement of the mowing head 3 relative to the fastening device 10 is blocked both towards the fastening device 10 and away from it. In an alternative embodiment, it can be expedient that only the axial relative movement of the mowing head 3 away from the fastening device 10 is blocked by the interaction of the holding contour 20 and the locking contour 56.

As shown in FIGS. 6 and 7, the locking contour 56 is designed as a groove 17 in the receiving unit 80. The receiving unit 80 is preferably formed from a body of revolution. Other geometries can also be advantageous. The groove 17 is preferably formed circumferentially on the receiving unit 80, in particular on a peripheral side 87 of the receiving unit 80. In an alternative embodiment, provision can be made for the groove 17 to be formed only in sections on the receiving unit 80. In the assembled state of the assembly 2, the receiving unit 80 protrudes through the opening 61 of the slide frame 60. The slide frame 60 with its holding contour 20 is clamped by the spring element 23 in the locking contour 56, in particular in the groove 17, of the receiving unit 80. The holding contour 20 is pretensioned against the locking contour 56 radially to the axis of rotation 9 by the spring element 23. In the blocking position 30, the spring element 23 presses the actuating element 24 with the slide frame 60 and the holding contour 20 into the locking contour 56, in particular into the groove 17 of the receiving unit 80. Thereby, the mowing head 3 is secured on the fastening device 10 and prevented from relative movement in the axial direction, i.e., is secured in the direction of the axis of rotation 9 of the output shaft 8.

As shown in FIGS. 8 and 9, in order to release the mowing head 3 from the fastening device 10 and from the output shaft 8, the actuating element 24 must be actuated by the operator. The holding contour 20 is pressed out of the locking contour 56 of the receiving unit 80 by the actuating element 24 against the spring force of the spring element 23, as a result of which the locking contour 56 and the holding contour 20 are no longer operatively connected. In this state, the axial lock 16 is in the inoperative position 31. In the inoperative position 31, the holding contour 20 does not form an axial stop for the locking contour 56, as a result of which the mowing head 3 can be pulled off the output shaft 8.

As shown in FIGS. 6 to 9, in the blocking position 30 of the axial lock 16 the holding contour 20 and the locking contour 56 form a form-fitting connection. Accordingly, the mowing head 3 can be pulled off the output shaft 8 only after the positive connection has been released by actuating the actuating element 24. The end of the receiving unit 80 facing the fastening device 10 has a chamfer 88. The locking contour 56 is formed adjacent to the chamfer 88. To attach the mowing head 3 to the output shaft 8, the mowing head 3 with its receiving unit 80 is simply pushed onto the output shaft 8. Due to the conicity of the chamfer 88 of the receiving unit 80, the holding contour 20 slides along the chamfer 88 until the latter jumps into the locking contour 56. The holding contour 20 is displaced radially to the axis of rotation 9 by the chamfer 88 of the receiving unit 80 without having to actuate the actuating element 24 in the process.

As indicated schematically in FIG. 8, a further opening 93 is provided in the receiving pocket 76 of the fastening device 10 in the particularly preferred embodiment. The further opening 93 forms a dirt chute, which extends from the receiving pocket 76 to the outside of the fastening device 10 facing the mowing head 3. The further opening 93 is provided approximately at the inner end of the receiving pocket 76 of the fastening device 10. Thereby, dirt located in the receiving pocket 76 can be conveyed out of the receiving pocket 76 through the further opening 93. As a result, the movement mechanism of the latching unit 18 cannot be blocked by dirt particles.

In the preferred embodiment of the assembly 2, a second spring element 89 is provided. The spring element 89 is arranged in such a way that, when the mowing head 3 is in the attached state, the spring element 89 exerts a pretension on the mowing head 3 which pushes the mowing head 3 away from the fastening device 10 in the direction of the axis of rotation 9. If the holding contour 20 is not correctly engaged in the locking contour 56, the mowing head 3 is pushed off the output shaft 8 by the second spring element 89. A further advantage of the second spring element 89 is that the mowing head 3 is prestressed against the fastening device 10 in such a way that there is no axial play between the holding contour 20 and the locking contour 56. In the preferred exemplary embodiment, the second spring element 89 is fastened at one end to the housing 4 of the mowing head 3. The other end of the second spring element 89 is supported against the output shaft 8, in particular against the intermediate shaft 72. The second spring element 89 is preferably designed as a helical spring.

As shown in particular in FIGS. 6 and 8, the mowing head 3 comprises, in addition to the receiving unit 80, the housing 4 and advantageously a hood 90. The housing 4 comprises a housing upper part 5 and a lower housing part 49. In particular, the upper housing part 5 forms the top side 35 of the mowing head 3, and the lower housing part 49 forms the bottom side 34. The upper housing part 5 and the lower housing part 49 are connected to one another via clip connections. The upper housing part 5 is pot shaped. The mowing head 3 includes a tool holder 37 provided on the housing 4. The tool holder 37 is provided to hold the cutting tool 7. In the present embodiment, the tool holder 37 is a line spool 6 for receiving a cutting line.

The line spool 6 is arranged in the pot-shaped upper part 5 of the housing. The line spool 6 can be rotated relative to the housing 4 via a feed device, as a result of which the cutting line is unwound from the line spool 6. The cutting line is guided outwards from the line spool 6 via openings in the housing 4. The feed device can be actuated by an actuating element 50 which is arranged on the bottom side 34 of the mowing head 3 in the exemplary embodiment. In the present exemplary embodiment, the actuating element 50 is formed by the lower housing part 49.

In an alternative embodiment of the mowing head 3, the tool holder 37 can also be designed to hold at least one cutting blade. It can also be expedient to provide a tool holder 37 which is designed in such a way that at least one cutting line and at least one cutting blade can be fastened to the mowing head 3. The tool holder 37 then consists of at least one holder for the cutting line and at least one holder for a cutting knife. The cutting blade is in particular a cutting blade made of plastic or a material of comparable density.

As shown in FIGS. 6 and 8, the upper housing part 5 is rotatably held on the receiving unit 80, in particular on the peripheral side 87 of the receiving unit 80, in the exemplary embodiment. The upper housing part 5 is held displaceably in the direction of the axis of rotation 9 relative to the receiving unit 80. The line spool 6 is corotatingly arranged on the receiving unit 80. Lugs are formed on the line spool 6 and engage in corresponding pockets on the inside of the upper part 5 of the housing. Thus, when the work apparatus 1 is in operation, the housing 4 is driven in rotation via the line spool 6, and the line spool 6 in turn is driven in rotation via the receiving unit 80. If the actuating element 50 is pressed, the housing 4 is displaced on the receiving unit 80 relative to the line spool 6 so that the lugs of the line spool 6 no longer engage in the pockets of the upper housing part 5. As a result, the line spool 6 rotates relative to the housing 4, whereby the cutting line unwinds from the line spool 6. The hood 90 is held on the receiving unit 80 in a rotationally fixed manner. The hood 90 is in particular fastened on the receiving unit 80 in a form-fitting manner with respect to the directions of rotation 32, 33. The hood 90 is preferably held on the receiving unit 80 via a splined connection 92 (FIG. 5). In order to wind a cutting line onto the line spool 6 without dismantling the mowing head 3 in the process, the operator can fix the line spool 6 indirectly by holding the hood 90 and rotate the housing 4 at the same time. This results in a relative rotation between the housing 4 and the line spool 6, which causes the cutting line to be wound up on the line spool 6. In order to be able to grip the hood 90 ergonomically, it extends radially to the axis of rotation 9 over the upper housing part 5 of the mowing head 3.

In an alternative embodiment, it can also be provided that the housing 4, in particular the housing upper part 5, is arranged in a rotationally fixed manner on the receiving unit 80 and the line spool 6 is rotatably arranged on the receiving unit 80 and/or a dome of the housing 4, in particular the housing upper part 5. The rotation of the output shaft 8 is transmitted to the housing 4 by the receiving unit 80 and the line spool 6 is carried along by the housing 4.

The operator can remove the mowing head 3 easily and without tools from the work apparatus 1 by means of the fastening device 10, which forms a quick-release fastener, and wind up the mowing head 3 away from the work apparatus 1 in an ergonomic position or exchange it for another mowing head 3 that is already filled. The quick-release fastener reduces the time it takes to change tools and/or improves ergonomics when changing tools.

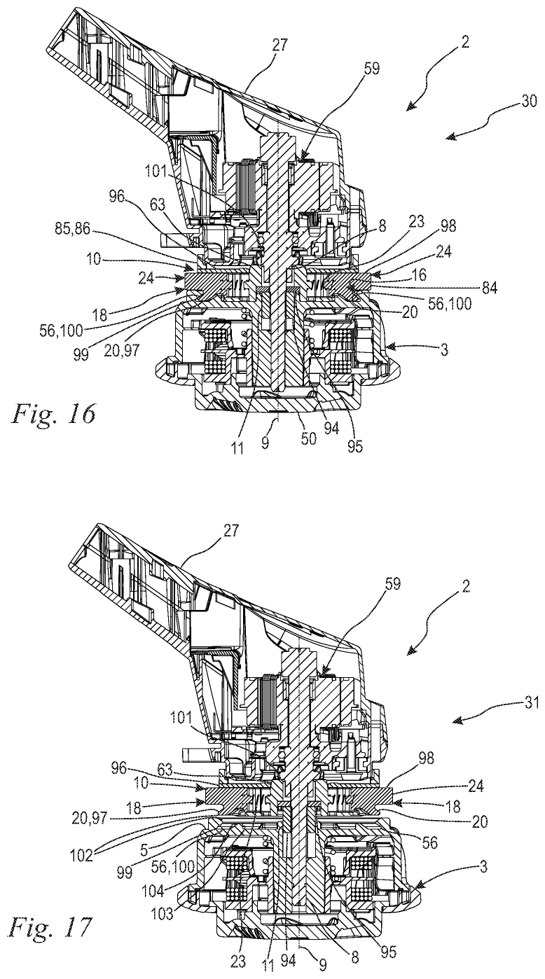

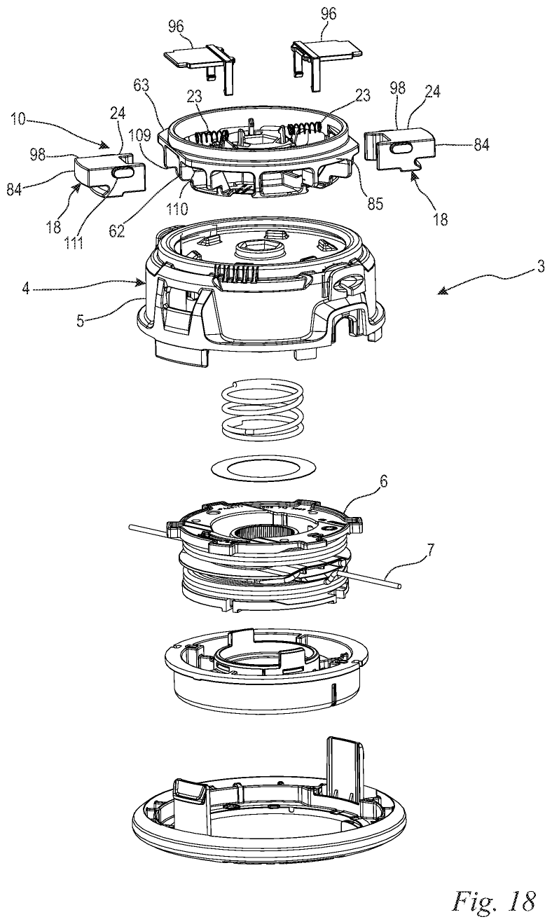

In the FIGS. 16 and 17 an alternative embodiment of the assembly 2 is shown. In this assembly 2, the fastening device 10 comprises two latching units 18. The latching units 18 are held in the base body 63 of the fastening device 10. The fan wheel 62 (FIG. 18) for generating a cooling air flow for the drive motor 59 is provided on the side of the base body 63 facing the front housing 27.

As shown in FIGS. 16 and 17, the latching unit 18 comprises the actuating element 24, the spring element 23 and a holding frame 96. The actuating element 24 is formed by a base body 98. The base body 98 has an approximately cubic geometry. A gripping hook 97 is formed on the side of the actuating element 24 facing the mowing head 3. The holding contour 20 is formed at the gripping hook 97. The gripping hook 97 is formed directly on the actuating element 24. The gripping hook 97 is preferably designed in one piece with the actuating element 24. The actuating element 24 has an inner side facing the axis of rotation 9, to which the spring element 23 is fastened at one end. The other end of the spring element 23 is supported against the base body 63 of the fastening device 10. The spring element 23 pretensions the actuating element 24 radially outwards in relation to the axis of rotation 9. The outer side 84 of the actuating element 24 together with the outer side 85 of the base body 63 of the fastening device 10 form the peripheral side 86 of the fastening device 10. The actuating element 24 is arranged in the fastening device 10 in such a way that it can be pressed in by the operator. The operator can contact the actuating element 24 directly and press it in radially to the axis of rotation 9. The actuating element 24 is held in a guided manner in the holding frame 96. As shown in FIG. 18, the fan wheel 62 is formed on the base body 63 of the fastening device 10. The fan wheel 62 serves to cool the drive motor 59. In addition, the base body 63 contains guide pockets 109 for the actuating elements 24 and a stop 110 which prevents the actuating elements 24 from falling out radially in the inoperative position 31. The stop interacts with a projection 111 of the actuating elements 24. The base body 63 of the fastening device 10 thus forms the fan wheel 62 and the guide pockets 109, i.e., the receptacles for the actuating elements 24. The base body 63 is formed in one piece.

As shown in FIGS. 16 and 17, the mowing head 3 comprises the locking contour 56, the locking contour 56 forming the axial lock 16 with the holding contour 20 of the fastening device 10. The locking contour 56 of the mowing head 3 is arranged on the upper part 5 of the housing. The locking contour 56 of the mowing head 3 is preferably arranged on the side of the upper housing part 5 facing the fastening device 10. The locking contour 56 is formed in the form of a circumferential counter hook 100. The counter hook 100 in turn forms a locking groove 99 into which the holding contour 20 of the latching unit 18 engages. Consequently, in the blocking position 30 (FIG. 16), the holding contour 20 and the locking contour 56 are engaged. The actuating elements 24 are pressed radially outwards in the direction of the axis of rotation 9, so that the gripping hooks 97 of the actuating elements 24 engage in the locking groove 99 of the housing upper part 5. Thereby, the mowing head 3 is secured against displacement in the direction of the axis of rotation 9 on the output shaft 8.

In FIG. 17 the assembly 2 is shown in the inoperative position 31. To release the mowing head 3 from the output shaft 8, the actuating elements 24 are to be pressed in the direction towards the axis of rotation 9 of the output shaft, so that the holding contours 20 and locking contours 56 no longer engage in one another. Accordingly, the mowing head 3 is no longer axially secured on the output shaft 8. The mowing head 3 can be pulled off the output shaft 8.

As shown in FIGS. 16 and 17, the fastening device 10 is fastened to the output shaft 8 by a nut 94 with a support washer 95. The fastening device 10 is pressed against a shaft shoulder 101 via the nut 94. The anti-rotation lock 11 between the mowing head 3 and the output shaft 8 is preferably formed by the outer geometry of the nut 94. The nut 94 is preferably designed as a hexagon. The mowing head 3 is in positive contact with the hexagon of the nut 94, as a result of which the mowing head 3 is corotatingly held on the output shaft 8. Other corotating connections between the mowing head 3 and the output shaft 8 can also be useful.

As shown in FIGS. 16 and 17, the gripping hooks 97 of the actuating elements 24 and the circumferential counter hook 100 on the upper housing part 5 each have bevels 102 which are formed on the top sides and bottom sides of the gripping hooks 97 and the counter hooks 100. The bevels are designed in such a way that when the mowing head 3 is pushed against the fastening device 10, the actuating elements 24 are pushed radially toward the axis of rotation, without having to actuate them directly, until the locking contour 56 and the holding contour 20 snap into place. In addition, a projection 103 running around the axis of rotation 9 is provided on the upper housing part 5. The projection 103 has a push-off surface 104 which runs obliquely to the axis of rotation 9 and which interacts with a back surface of the gripping hook 97. When the actuating elements 24 are actuated, the back surfaces of the gripping hook 97 interact against the push-off surface 104 in such a way that the mowing head 3 is pushed away in the direction away from the fastening device 10.

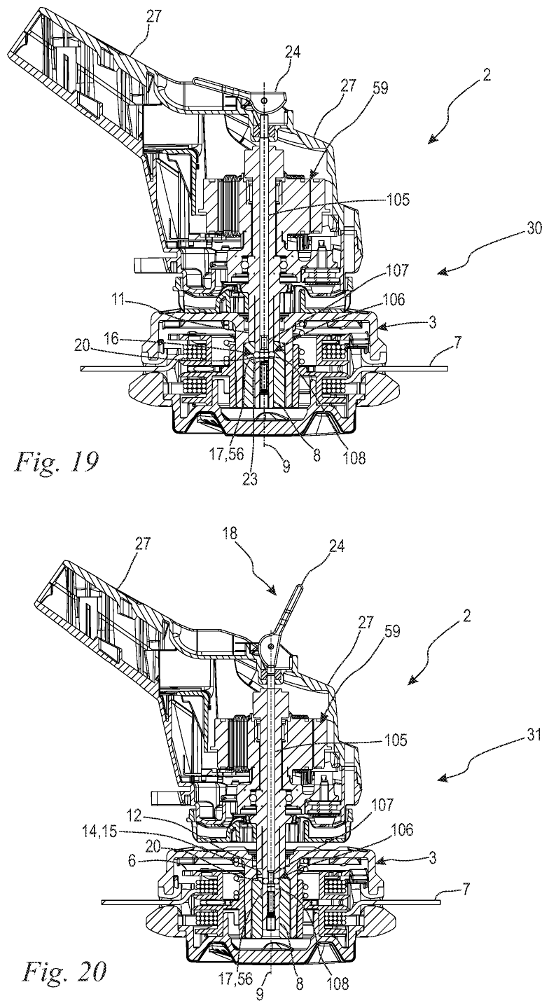

In FIGS. 19 and 20 an alternative embodiment of the assembly 2 is shown. In this assembly 2, the locking contour 56 is formed on the mowing head 3. In the exemplary embodiment, the locking contour 56 is formed directly on a hub of the mowing head 3. The locking contour 56 is designed as a groove in the hub of the mowing head 3. The holding contour 20 is formed by at least one ball in the embodiment. The at least one ball lies in an opening 106 of the output shaft 8. In the blocking position 30 of the axial lock 16, the at least one ball lies partly in the locking contour 56 and partly in the opening 106 of the output shaft 8. As a result, the mowing head 3 is held on the output shaft 8 by the at least one ball. In the inoperative position 31 of the axial lock 16, the at least one ball is located completely in the opening 106 of the output shaft 8. The mowing head 3 is no longer secured by the fastening device 10 in the direction of the axis of rotation 9 and can be pulled off (FIG. 20).

As shown in FIGS. 19 and 20, the output shaft 8 is designed as a hollow shaft. A locking rod 105 protrudes through the hollow shaft. A further groove 107 and a contact surface 108 adjoining the groove 107 are provided on the locking rod 105. The diameter of the contact surface 108 is larger than the diameter of the groove 107. In the blocking position 30, the locking rod 105 is aligned in such a way that the contact surface 108 rests against the ball and presses it into the locking contour 56. In the process, the ball is pressed radially outwards into the locking contour 56 by the contact surface 108 of the locking rod 105 in relation to the axis of rotation 9. In this position, the ball as the holding contour 20 of the locking rod 105 and the locking contour 56 of the mowing head 3 are in engagement, as a result of which the mowing head 3 is held on the output shaft 8. In the inoperative position 31 of the axial lock 16, the locking rod 105 is aligned in such a way that the ball lies in the further groove 107 of the locking rod 105 and in the opening 106 of the output shaft 8. The ball no longer blocks the mowing head 3. The mowing head 3 can be pulled off the output shaft 8. In the present embodiment, two balls are provided as holding contours 20.

As shown in FIGS. 19 and 20, the locking rod 105 is actuated via the actuating element 24, which in the present exemplary embodiment is designed as a quick-release lever. The locking rod 105 is biased by the spring element 23 in the direction from the mowing head 3 to the front housing 27. In the present exemplary embodiment, the fastening device 10 is formed by the latching unit 18. The latching unit 18 comprises the actuating element 24 designed as a quick-release lever, the locking rod 105, the spring element 23, and the balls with the holding contour 20.

In the preferred exemplary embodiment, the anti-rotation lock 11 of the mowing head 3 is formed by a first part 12, a hexagonal section of the output shaft 8, and by a second part 14, a corresponding counter-contour 15 of the mowing head 3. Thus, the mowing head 3 and the output shaft 8 are positively connected to each other in the circumferential direction of the axis of rotation 9.

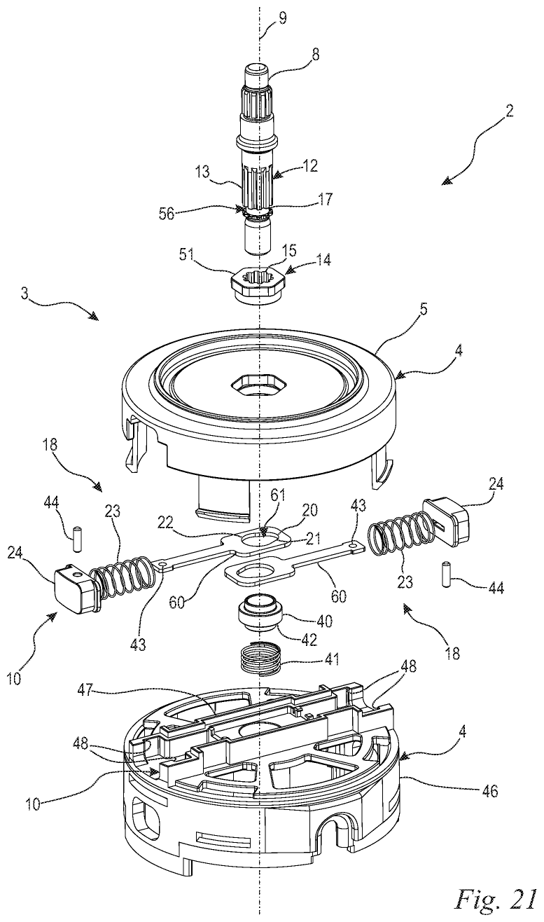

In FIGS. 21 to 24 an additional, alternative embodiment of the assembly 2 is shown. FIG. 21 shows the assembly 2 of the fastening device 10, the mowing head 3, and the output shaft 8 in an exploded view. As also shown in FIG. 21, the assembly 2 includes the anti-rotation lock 11 and the axial lock 16. In the present embodiment, the first part 12 of the anti-rotation lock 11 is designed as a wedge-shaped shaft section 13 of the output shaft 8 (FIG. 21). The output shaft 8 is designed in one piece. Wedge-shaped shaft section 13 means that at least one wedge-shaped lug is formed circumferentially along this shaft section, whereby the torque can be positively transmitted from the output shaft 8 to the hub, here the housing 4 of the mowing head 3. The wedge-shaped shaft section 13 is preferably formed from a plurality of wedge-shaped lugs. The second part 14 of the anti-rotation lock 11 is a counter-contour 15 which is formed on the housing 4 and which is in engagement with the wedge-shaped shaft section 13 of the output shaft 8. The second part 14 is formed by an insert 51 which is positively connected to the housing upper part 5 in the circumferential direction of the axis of rotation 9 (FIG. 21). Alternatively, the insert 51 can also be pressed in. Other fastenings of the insert 51 in the upper housing part 5 can also be used. Alternatively, the second part 14 can be formed directly on the upper housing part 5 of the housing 4. The output shaft 8 and the mowing head 3 are directly connected to one another by the first part 12 and the second part 14 of the anti-rotation lock 11. By means of the anti-rotation lock 11, the mowing head 3 is preferably held in only a rotationally fixed manner on the output shaft 8, as a result of which a displacement of the wedge-shaped shaft section 13 in relation to the counter-contour 15 of the housing 4 in the direction of the axis of rotation 8 is possible.

In the exemplary embodiment, the axial lock 16 of the assembly 2 comprises two latching units 18, which are provided on the mowing head 3, and a locking contour 56 formed on the output shaft 8. The locking contour 56 is also designed as a groove 17 in the exemplary embodiment. In the blocking position 30, the latching unit 18 engages in the groove 17 and thus blocks an axial displacement of the mowing head 3 on the output shaft 8. In the blocking position 30, the mowing head 3 is secured on the output shaft 8 in the direction of the axis of rotation 9. In the inoperative position 31 of the mowing head 3, the latching unit 18 releases the groove 17 and thus the output shaft 8. The mowing head 3 can be displaced on the output shaft 8 in the direction of the axis of rotation 9. The mowing head 3 can be removed from the output shaft 8.

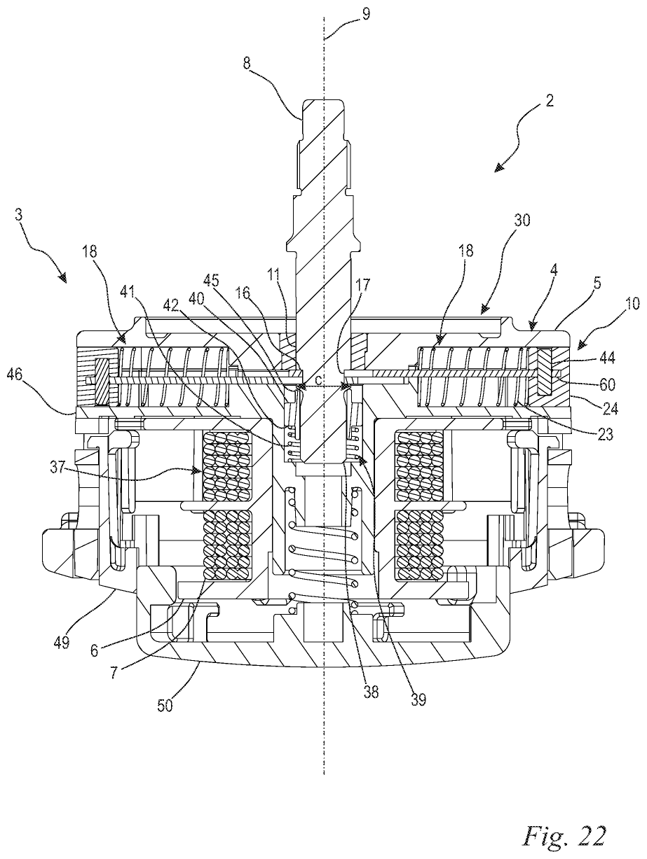

As shown in FIG. 21, the latching unit 18 includes the slide frame 60. The slide frame 60 has the holding contour 20. In the blocking position 30, the holding contour 20 of the latching unit 18 interacts with the locking contour 56. The mowing head 3 is secured on the output shaft 8. In the preferred embodiment, the slide frame 60 has the opening 61 at one end. The holding contour 20 is provided at the opening 61. The output shaft 8 protrudes through the slide frame 60 at its opening 61 (FIG. 22), wherein the retaining holding contour 20 interacts with the groove 17 of the output shaft 8 in the blocking position 30. In an alternative embodiment, the slide frame 60 can have a different structural design with a holding contour 20 at one end instead of an opening 61. For example, the slide frame 60 can have an L-shaped end which engages behind the output shaft 8, the holding contour 20 being formed at the end of the slide frame 60. Other structural configurations of the slide frame 60 can also be used. The actuating element 24, via which the operator can actuate the slide frame 60, is arranged at the other end of the slide frame 60. The actuating element 24 is fastened to the slide frame 60 via a pin 44, the pin 44 protruding through a further opening 43 which is provided at the other end of the slide frame 60. The slide frame 60 is flat in the exemplary embodiment, but it can also be expedient to form the slide frame 60 in the form of a round profile or the like. In particular, it can be provided that the slide frame 60 is wedge-shaped in the area of the holding contour 20. In an alternative embodiment of the latching unit 18, it can also be expedient to form the slide frame 60 and the actuating element 24 in one piece. The latching unit 18 of the axial lock 16 advantageously overlaps the anti-rotation lock 11 in the axial direction in order to reduce the axial overall height.

As shown in FIG. 21, the opening 61 has a non-circular shape. In the exemplary embodiment, the opening 61 is in the form of a keyhole. The opening 61 comprises a first section 21 and a second section 22 adjacent to the first section 21. The diameter a of the first section 21 is smaller than the diameter b of the second section 22 (FIG. 24). When mounting and dismounting the mowing head 3 on the output shaft 8, the latching unit 18 is in the inoperative position 31, as a result of which the output shaft 8 extends through the second section 22 of the opening 61. The diameter b of the second section 22 is larger than the maximum diameter c of the end section of the output shaft 8 to be threaded. In the blocking position 30 of the latching unit 18, the holding contour 20 formed on the first section 21 bears against the groove 17 of the output shaft 8, after which the output shaft 8 extends through the first section 21 of the output shaft 8. The diameter a of the first section 21 is smaller than the maximum diameter c of the end section 38 of the output shaft 8. As a result, an axial displacement of the mowing head 3 in the direction of the axis of rotation 9 is blocked in the blocking position 30.

As shown in FIG. 21, the latching unit 18 includes the spring element 23 which tensions the holding contour 20 of the latching unit 18 in the groove 17 of the output shaft 8. In the present exemplary embodiment, the spring element 23 is supported on the housing 4 and acts on the actuating element 24 of the latching unit 18 in such a way that the actuating element 24 and the slide frame 60 are tensioned radially to the axis of rotation 9 in the direction away from the output shaft 8. The spring element 23 is designed as a helical spring. Other types of springs can also be expedient in an alternative embodiment.

In FIG. 22 the latching unit 18 is shown in the blocking position 30. The spring element 23 tensions the slide frame 60 radially outwards via the actuating element 24, as a result of which the holding contour 20 of the opening 61 of the slide frame 60 is held in the groove 17 of the output shaft 8. This clamping force is increased during operation of the mowing head 3 since the centrifugal forces act radially outwards on the slide frame 60 with respect to the axis of rotation 9. Thus, the holding contour 20 of the slide frame 60 is clamped into the groove 17 of the output shaft 8 by the spring force of the spring element 23 and the centrifugal forces acting on the slide frame 60. An axial displacement of the mowing head 3 on the output shaft 8 is not possible. The axial movement of the mowing head 3 relative to the output shaft 8 is blocked.

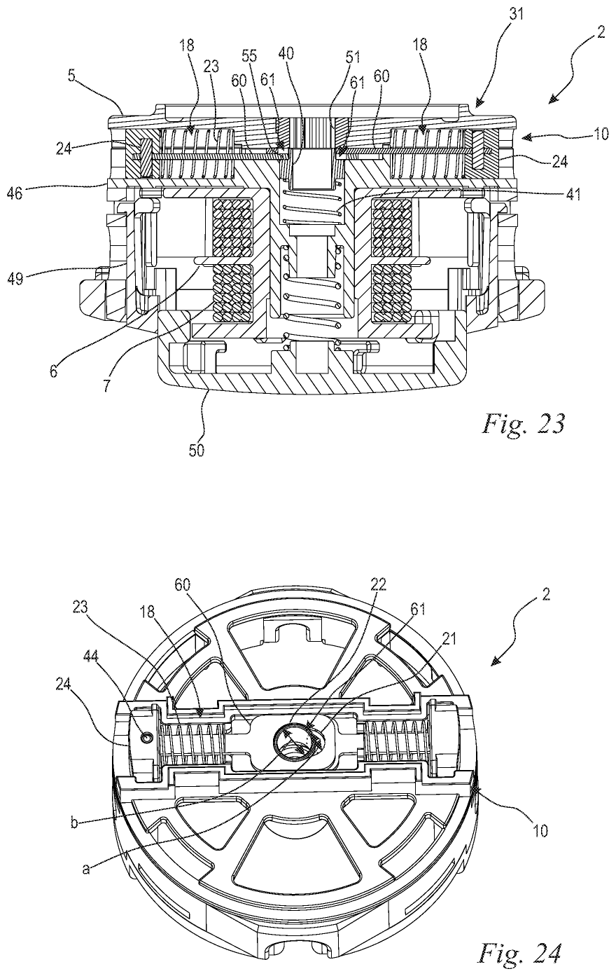

In FIG. 23 the assembly 2 is shown in the inoperative position 31 of the mowing head 3. In order to detach the mowing head 3 from the output shaft 8, the operator must press in both latching units 18 against the spring force of the spring element 23 towards the output shaft 8. For this purpose, the actuating element 24, which is accessible to the operator, is pressed in from the outside. The slide frame 60 is thereby displaced, with the holding contour 20 being pushed out of the groove 17 at the opening 61 of the slide frame 60. In this position, the holding contour 20 and the groove 17 no longer cooperate. The mowing head 3 is in the inoperative position 31 and can be pulled off the output shaft 8.

In the present exemplary embodiment, two latching units 18 are provided, which are arranged on opposite sides of the axis of rotation 9. The latching units 18 are offset from one another at an angle of approximately 180°, measured about the axis of rotation 9. This ensures that the mass of the mowing head 3 is evenly distributed. An imbalance in the operation of the mowing head 3 can be avoided. If, in an alternative embodiment, the mowing head 3 comprises only one latching unit 18, a separate mass balance should preferably be provided. If more than two latching units 18 are provided on the mowing head 3, these are to be arranged at equal angular distances about the axis of rotation 9 from one another for uniform mass distribution. The latching units 18 are offset from one another at a uniform angular distance about the axis of rotation 9.

As shown in FIGS. 22 and 23, the mowing head 3 includes a tensioning device 39. The tensioning device 39 is used to keep the latching unit 18 open in the inoperative position 31, as a result of which the mowing head 3 can be pushed onto the output shaft 8 without manually actuating the actuating elements 24. Another function of the tensioning device 39 is to clamp the mowing head 3 axially in the direction of the axis of rotation 9 against the output shaft 8. As a result, play in the axial direction between the mowing head 3 and the output shaft 8 can be reduced or avoided. The tensioning device 39 comprises a sleeve 40 and an axial spring 41. The sleeve 40 is seated on the end section 38 of the output shaft 8 and is slidably mounted in the direction of the axis of rotation 9. The axial spring 41 is supported at one end on a shoulder 42 of the sleeve 40, the sleeve 40 in turn bearing against a shaft shoulder 45 of the output shaft 8. With its other end, the axial spring 41 acts on the housing 4. If the assembly 2 is mounted, the axial spring 41 acts on the housing 4 of the mowing head 3 in such a way that the housing 4 is pressed along the axis of rotation 9 in the direction away from the output shaft 8, with the latching unit 18 being braced axially in the groove 17. If the mowing head 3 is in the inoperative position 31 (FIG. 23), the axial spring 41 pushes the sleeve 40 upwards until the sleeve 40 comes to rest on the slide frame 60 of the latching unit 18 with a rear shoulder 55 facing away from the shoulder 42. If the operator lets go of the actuating elements 24, the spring element 23 pushes the slide frames 60 in the direction away from the axis of rotation 9 until the slide frame 60 comes into contact with the sleeve 40 with its holding contour 20. The sleeve 40 thus keeps the slide frame 60 open, as a result of which the mowing head 3 can be slid onto the output shaft 8 again without manually actuating the actuating elements 24 for this purpose. Furthermore, the tensioning device 39 uses its sleeve 40 to cover an undercut formed in front of the shaft shoulder 45. This prevents the actuating elements 24 from latching into the undercut.

In an alternative embodiment of the output shaft 8, it can be expedient to provide only a shoulder or the circumferential shaft shoulder 45 on the output shaft 8 instead of the groove 17. The latching unit 18 is then tensioned by the axial spring 41 against the step or the circumferential shaft shoulder 45, as a result of which the mowing head 3 is also secured on the output shaft 8 in the blocking position 30.

As shown in particular in FIG. 21, the fastening device 10 comprises the latching units 18 and a guide 47 for the latching units 18. At the guide 47 stops 48 are formed, against which the actuating element 24 comes to rest. The fastening device 10 is fastened on an intermediate housing part 46 of the mowing head 3. In this exemplary embodiment, the fastening device 10 thus forms an integral part of the mowing head 3.

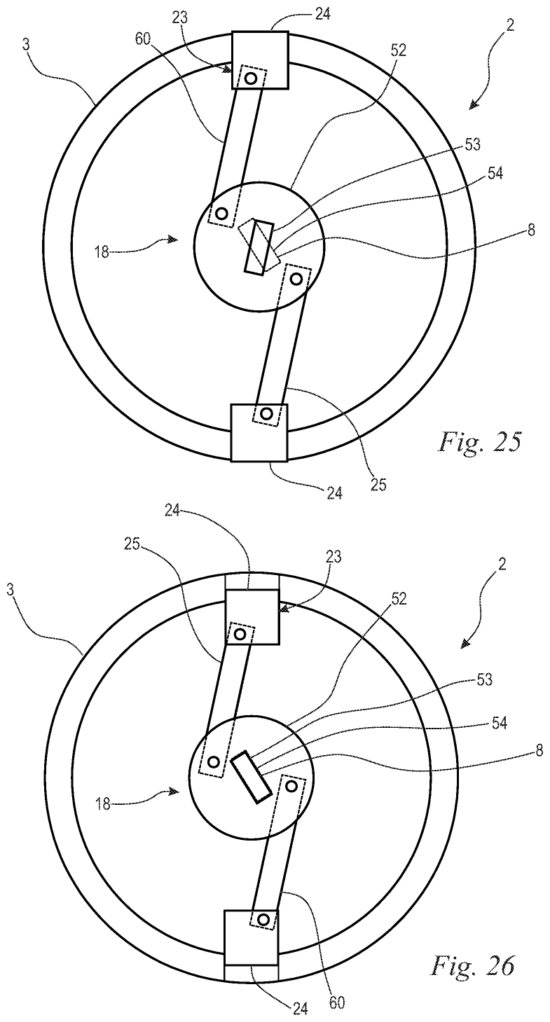

An additional, alternative exemplary embodiment of the assembly 2 is shown in FIGS. 25 and 26, which is only shown schematically. The fastening device 10 includes a latching unit 18 which has two actuating elements 24 and two slide frames 60. The slide frames 60 are coupled to a plate 52 that can be pivoted about the axis of rotation 9, the plate 52 being part of the latching unit 18. The plate 52 is arranged coaxially with the output shaft 8. The plate 52 has an opening 61 which is designed as a blocking opening 53 in the exemplary embodiment. The output shaft 8 extends through the blocking opening 53 of the plate 52. In FIG. 24 latching unit 18 is shown in the blocking position 30. Accordingly, the blocking opening 53 is arranged offset to the cross-sectional contour 54 of the output shaft 8 at its end section 38. Accordingly, the mowing head 3 is positively held on the output shaft 8 via the plate 52 in the blocking position 30. To release the mowing head 3 from the output shaft 8, the actuating elements 24 must be pressed. The plate 52 is pivoted by the slide frame 60 coupled to the actuating elements 24 until the blocking openings 53 are congruent with the cross-sectional contour 54 of the output shaft 8 (FIG. 25). The positive connection between the output shaft 8 and the mowing head 3 in the direction of the axis of rotation 9 is eliminated, as a result of which the mowing head 3 can be detached from the output shaft 8. The blocking opening 53 and the cross-sectional contour 54 of the output shaft 8 corresponding to the blocking opening 53 can have any desired geometries that enable such a blocking mechanism.

In the present exemplary embodiment, the geometry of the blocking opening 53 is rectangular. In this embodiment of the assembly 2, there is also a self-reinforcing clamping effect of the latching unit 18 due to the action of centrifugal forces. The centrifugal forces cause the slide frames 60 with the actuating elements 24 to be accelerated radially outwards with respect to the axis of rotation 9 and thereby hold the plate 52 with the opening 61 in the blocking position 30. Since the center of mass of the actuating element 24 and the slide frame 60 directly coupled to the actuating element are outside of the axis of rotation 9, the centrifugal force causes an acceleration towards the center of mass of the actuating element 24 and the slide frame 60, starting from the axis of rotation 9, radially outwards. In this way, the clamping effect of the latching unit 18 is reinforced.

The mowing head 3 is preferably designed in such a way that the mowing head 3 can be attached to the output shaft 8 and detached therefrom as a coherent unit. Individual parts designed separately from the mowing head 3, for example for fastening the mowing head 3 to the output shaft 8, are not provided. This facilitates assembly and disassembly of the assembly 2. Furthermore, in addition to the mowing head 3 and the output shaft 8, the assembly has no further individual parts which the user could lose when assembling or disassembling the assembly 2.

In an alternative exemplary embodiment of the assembly 2, it can be expedient to provide an adapter part, in particular a sleeve, on the output shaft 8. The adapter part is arranged between the output shaft 8 and the mowing head 3. The anti-rotation lock 11 between the output shaft 8 and the mowing head 3 is formed by the adapter part. The adapter part is preferably positively connected to the output shaft 8 in the direction of rotation about the axis of rotation 9. The adapter part is preferably positively connected to the mowing head 3 in the direction of rotation about the axis of rotation 9.

What is claimed is:

1. An assembly, comprising:
a mowing head (3),
an output shaft (8) for receiving the mowing head (3), and
a fastening device (10) for fixing the mowing head (3) on the output shaft (8),
wherein the output shaft (8) can be driven to rotate about an axis of rotation (9),
wherein the assembly (2) has an anti-rotation lock (11) and an axial lock (16),
wherein the mowing head (3) is held corotatingly on the output shaft (8) by the anti-rotation lock (11),
wherein the axial lock (16), in a blocking position (30), positively secures the mowing head (3) on the output shaft (8) against relative movement along the axis of rotation (9) of the output shaft (8) and, in an inoperative position (31), releases the mowing head (3) for detachment from the output shaft (8), and
wherein the fastening device (10) comprises an actuating element (24) accessible to an operator, the axial lock (16) being switchable into the blocking position (30) and into the inoperative position (31) by means of the actuating element (24).

2. The assembly according to claim 1,
wherein the anti-rotation lock (11) is designed as a positive connection.

3. The assembly according to claim 1,
wherein the mowing head (3) can be attached to and detached from the output shaft (8) without tools.

4. The assembly according to claim 1,
wherein the axial lock (16) comprises a holding contour (20) and a locking contour (56), and
wherein the holding contour (20) engages the locking contour (56) in the blocking position (30) of the axial lock (16).

5. The assembly according to claim 4,
wherein the holding contour (20) is designed to be in radially displaceable with respect to the axis of rotation (9) of the output shaft (8) by the actuating element (24).

6. The assembly according to claim 5,
wherein the holding contour (20) is part of the fastening device (10), and
wherein the locking contour (56) is formed on the mowing head (3).

7. The assembly according to claim 5,
wherein the holding contour (20) is part of the mowing head (3), and
wherein the locking contour (56) is formed on the output shaft (8).

8. The assembly according to claim 4,
wherein the holding contour (20) is formed on a slide frame (60).

9. The assembly according to claim 8,
wherein the slide frame (60) comprises an opening (61), and
wherein the locking contour (56) is arranged in the opening (61) of the slide frame (60).

10. The assembly according to claim 4,
wherein the holding contour (20) is formed by at least one blocking body engaging in the locking contour (56).

11. The assembly according to claim 4,
wherein the holding contour (20) is formed by a ball engaging in the locking contour (56).

12. The assembly according to claim 1,
wherein the fastening device (10) comprises a one-piece base body (63), and
wherein a fan wheel (62) is formed on the base body (63) of the fastening device (10).

13. The assembly according to claim 12,
wherein the base body (63) has a receiving pocket (76), and
wherein the actuating element (24) of the fastening device (10) is held in the receiving pocket (76).

14. The assembly according to claim 4,
wherein the assembly (2) comprises a spring element (23), and
wherein the spring element (23) is operatively connected to the holding contour (20) in such a way that the holding contour (20) is clamped into the locking contour (56).

15. The assembly according to claim 4, further comprising
a latching unit (18),
wherein the latching unit (18) comprises
the actuating element (24),
the holding contour (20), and
all components by which the holding contour (20) and the actuating element (24) are operatively connected to one another,
wherein a center of mass of the latching unit (18) lies outside the axis of rotation (9) in such a way that, during operation of the assembly (2), centrifugal forces acting on the latching unit (18) reinforce a clamping of the holding contour (20) against the locking contour (56) in the blocking position (30).

16. A handheld work apparatus comprising the assembly according to claim 1.
